(19) United States
(12) Patent Application Publication
(10) Pub. No.: US 2010/0063678 A1
(43) Pub. Date: Mar. 11, 2010

(54) MOTION CONTROL SENSOR SYSTEM FOR A MOVING UNIT AND MOTION CONTROL SYSTEM

(75) Inventor: Satoshi YAMAMOTO, Hitachi (JP)

Correspondence Address: MATTINGLY & MALUR, P.C., 1800 DIAGONAL ROAD, SUITE 370, ALEXANDRIA, VA, 22314, US

(73) Assignee: HITACHI CABLE, LTD., Tokyo (JP)

(21) Appl. No.: 12/503,532

(22) Filed: Jul. 15, 2009

(30) Foreign Application Priority Data
Sep. 10, 2008 (JP) 2008-232272

(51) Int. Cl. B60G 17/0165

(52) U.S. Cl. 701/37

(57) ABSTRACT

A motion control sensor system and motion control system for a moving unit have a physical quantity sensor in an unsprung mass of the moving unit so that physical quantities in the unsprung mass can be detected, bypassing the spring. An acceleration sensor for detecting acceleration exerted on the unsprung mass of the moving unit is placed so that its detection axis crosses the operation axis of the moving unit, so acceleration due to angular acceleration around the operation axis is not detected. Accordingly, the motion control sensor system and motion control system are suitable for running stability control during cornering of the moving unit.

The present application is based on Japanese Patent Application No. 2008-232272 filed Sep. 10, 2008, the entire contents of which are incorporated herein by reference.

### TECHNICAL FIELD

The present invention relates to a motion control sensor system, for a moving unit, that is suitable for running stability control during cornering of the moving unit, and also relates to a motion control system.

### BACKGROUND ART

Systems have been developed, which control braking, driving, and maneuvering of the vehicles according to results of vehicle motion measurement, in order to improve braking and driving performance of vehicles and to increase their maneuvering stability

Anti-lock braking systems and traction control systems are widely used, which use wheel speed sensors for detecting the rotational speeds of the wheels of a vehicle to suppress the wheels from locking or slipping.

FIGS. 13 and 14 show conventional motion control systems on which wheel speed sensors are mounted. FIG. 13 is a rear view of the front wheel on the right side of a front-wheel-drive car, indicating a situation around the front wheel of a strut suspension generally used for vehicle suspension. FIG. 14 is a plan view partially indicating the top of the motion control system in FIG. 13.

The tire 101 is generally inclined by a camber angle (about one degree) with respect to the vertical axis V to increase stability during straight ahead movement or cornering. The tire 101 is connected to the rotating part of the hub 102 through a wheel (not shown). The rotating part of the hub 102 is connected to the drive shaft 103 that transmits the rotation of the engine.

The hub 102 is supported (rigidly connected) by a knuckle 104. The knuckle 104 is rigidly connected to the lower part of a shock absorber 105 at the top, that is, connected to the vehicle body (indicated by a boundary wall 106 along the engine room in FIG. 13) through the shock absorber 105.

A spring 107 is attached to the top of the shock absorber 105 so that a damper function of the shock absorber 105 and an elastic function of the spring 107 alleviate upward and downward motions caused due to unevenness of the road surface H and by rolling and pitching of the vehicle body during cornering. That is, the shock absorber 105 serves to alleviate and converge reaction (periodic vibration) due to the characteristics of the spring 107.

The lower part of the knuckle 104 is connected to a lower arm 108 by a ball joint 109, as shown in FIG. 14. The lower arm 108 is connected to a vehicle body part 110 through a rubber bushing (not shown) to cause the motion of the lower arm 108 to alleviate. A tie rod 111 for changing the orientation of the wheels (turning the wheels) is connected to the knuckle 104. When the tie rod 111 moves right and left, the knuckle 104 turns in the directions indicated by the arrows in FIG. 14, with the ball joint 109 being a fulcrum. The orientation of the wheels of the vehicle is changed as the wheels turn around a turning axis S, enabling the vehicle to corner.

As described above, the spring 107, shock absorber 105, knuckle 104, hub 102, brake rotor 112, drive shaft 103, tie rod 111, and other various types of parts are placed between the tire 101 and parts of the vehicle body (such as the boundary wall 106 along the engine room and the vehicle body part 110). In this application, an area below the spring 107 in the path from the vehicle body to the tire is referred to as an unsprung mass, and a part included in the area is referred to as an unsprung mass part. When, however, a part is partially included in the unsprung mass, only the portion included in the unsprung mass is referred to as an unsprung mass part. Specifically, for the shock absorber 105, a portion below the spring 107 is an unsprung mass part. Similarly, an area above the spring 107 is referred to as a sprung mass.

In an exemplary arrangement to detect the rotational speed of the wheel, which includes the tire 101, a wheel frame (not shown), and the hub 102, a magnetic encoder is attached to the outer circumference of a rotational body of the hub 102, which rotates together with the wheel, and a magnetic sensor is attached to a non-rotational part of the hub 102, the magnetic encoder having S poles and N poles alternately, the magnetic sensor being included in a wheel speed sensor head 113. The rotational speed of the wheel is obtained from a change in the speed output from the magnetic sensor.

A cable 114 connected to the wheel speed sensor head 113 passes through the unsprung mass, that is, passes about three fixed parts placed below the shock absorber 105 and on the boundary wall 106 along the engine room (fixed parts located on the boundary wall 106 along the engine room belong to the sprung mass) and is connected to a wheel speed sensor signal processing circuit (not shown) in the engine room. The cable 114 swings when the wheels turn, so the cable is slackened to prevent any excessive tension from being applied to it.

The hub 102, on which the wheel speed sensor head 113 is mounted, is positioned near the rotor of the disk brake or drum brake. These brakes are heated to several hundreds of degrees Celsius due to braking. When the vehicle continues to run, a cooling effect provided during the running prevents further heat generation and transmission of the heat to surrounding areas. When, however, the vehicle stops immediately after the brake is applied, heat is built up and thereby the temperature around the wheel speed sensor head 113 rises. Accordingly, it must be considered that the maximum service temperature of the wheel speed sensor head 113 is allowed up to about 150° C.

Therefore, even when a drum brake is used instead of a disk brake, a situation is same as when the disk brake is used in terms of a point that the hub 102 is placed near the drum that becomes hot.

A system for achieving stable running at curves by suppressing under steering and over steering is also being developed, in which at least one of a single acceleration sensor for measuring a lateral acceleration and a single angular speed sensor for measuring an angular rotation speed in a horizontal plane (yaw rate) is used (for example, see the homepage of ESC Spreading Committee: http://www.esc-jpromo-activesafety.com/about.html).

The system detects a lateral acceleration and an angular rotation speed in a horizontal plane generated in a vehicle when a reactive force is generated from the road surface during the motion of the vehicle. The lateral acceleration sensor for detecting lateral acceleration and a yaw rate sensor for detecting an angular rotation speed in a horizontal plane are usually mounted on the vehicle body near the center of gravity of the vehicle. These sensors are detecting conditions of the tire and the road surface through a suspension, so detected information is delayed with respect to input (reactive force) from the road surface. Accordingly the sensors are not contributing to an accurate control.

To solve this problem, sensors such as acceleration sensors are attached to the tires in JP2004-98709A. In this method, however, since the tires to which the sensors are attached are rotated to run the vehicle, power supply to the rotating parts and wireless information transmission from the rotating parts are needed, making the system very complex. Another problem is that the information transmission may be discontinued.

In a method proposed in JP2007-271005A to solve these problems, a strain sensor is attached to a non-rotational part of the hub, which connects the tire and wheel frame, which are rotating bodies, to the non-rotating part, to detect a load applied to the hub. Since this method is intended to detect starin of the hub, which is a structural body, however, effects other than the axis from which to detect distortion must be compensated. To perform this compensation, a plurality of strain sensors must be used to detect distortion in the direction of one axis. The hub to which the plurality of strain sensors is attached is positioned near the brake. When the brake is applied, portions at which the strain sensors are attached become hot due to heat generated by the brake. Accordingly, changes in temperature make it difficult to perform precise measurements and various devices are required to obtain reliable measurement precision, resulting in an expensive method.

As a method for detecting a load applied to the hub, a method of using a plurality of rotational speed sensors to detect hub deformation caused by the applied load is disclosed in JP2004-003918A. Specifically, the hub deformation is determined by obtaining a load applied to the hub with displacement sensor units placed at four places on the hub. This method requires a high cost because four displacement sensor units are needed.

In the system being studied to increase stability of running during cornering, detection results of a lateral acceleration, an angular rotation speed in a horizontal plane (yaw rate), or a load applied to the vehicle or displacement are used.

When acceleration sensors or yaw rate sensors are installed on sprung mass of the vehicle, there are advantages that the number of sensors attached can be reduced and a temperature-changing range in the environment, in which the sensors are attached, becomes relatively narrow. However, signals detected are delayed with respect to a response from the road surface, so the response time has been required to be further reduced.

When a sensor is attached to the tire to reduce the response time, the sensor is attached to the rotational part, so power must be supplied to the rotational part and information must be transferred from the rotational part.

In the system in which a sensor is attached to the non-rotational part of the hub, the temperature in the environment in which the sensor is attached is raised. In a system in which strain sensors are used, a plurality of sensors must be attached to correct the sensitivity of other axes, increasing the cost.

### SUMMARY OF THE INVENTION

An object of the present invention is to propose a motion control sensor system, for a moving unit, that is suitable for running stability control during cornering of the moving unit, and also propose a motion control system.

Particularly, since the effect of temperature generated by a brake on sensors is reduced, a service temperature range characteristic of the sensors environment of use can be narrowed and thereby it becomes easily possible to increase the precision of the sensors and reduce their costs.

In addition, motion being affected by a wheel turning operation is avoided.

Since a plurality of physical quantity sensors for detecting physical quantities such as vehicle speed sensors and lateral acceleration sensors used to prevent tires from locking and slipping are used in combination, the cost and weight of the entire vehicle control system are reduced and materials used in the system and assembling costs are also reduced.

An actual wheel turning angular speed is also obtained.

According to a first aspect of the present invention, the motion control sensor system for a moving unit such as a vehicle has physical quantity sensors in the unsprung mass, which is positioned below a spring attached to a member for supporting a wheel to the vehicle body in a path from the vehicle body to the wheel.

According to a second aspect of the present invention, an acceleration sensor for detecting acceleration exerted on the unsprung mass of the moving unit can be used as the above physical quantity sensor. The acceleration sensor can be placed so that its detection axis crosses the turning axis of the moving unit.

According to a third aspect of the present invention, a first acceleration sensor and a second acceleration sensor for detecting acceleration exerted in the unsprung mass of the moving unit can be used as the physical quantity sensors. The first acceleration sensor can be placed so that its detection axis crosses the turning axis of the moving unit, and the second acceleration sensor can be placed so that its detection axis is parallel to the detection axis of the first acceleration sensor and does not cross the turning axis of the moving unit.

According to a fourth aspect of the present invention, a plurality of physical quantity sensors can be placed in the unsprung mass of the moving unit, and the plurality of physical quantity sensors can be interconnected through a series of cables.

According to a fifth aspect of the present invention, the motion control system uses the motion control sensor system for a moving unit described in any one of the first aspect to the fourth aspect.

The present invention provides superior effects as described below.

(1) It is possible to provide a motion control sensor system, for a moving unit, that is suitable for running stability control during cornering of the moving unit, as well as a motion control system.

(2) The physical sensors are not easily affected by heat generated by a brake, so a temperature-changing range in a use environment can be narrowed, making the physical quantity sensors highly precise and inexpensive.

(3) Motion being affected by a turning operation is avoided.

(4) Since a plurality of physical quantity sensors for detecting physical quantities are used in combination, the cost and weight of the entire vehicle control system are reduced and materials used in the system and assembling costs are also reduced.

(5) An actual turning angular speed is obtained.

### BRIEF DESCRIPTION OF DRAWINGS

FIG. 1 illustrates the structure of a motion control system to explain the principle of the present invention.

FIG. 2 is a partial plan view of the motion control system in FIG. 1.

FIG. 3 illustrates a relation between a wheel turning axis S and detection axes.

FIG. 4 illustrates a relation between the wheel turning axis S and the detection axes of two-axis sensors.

FIG. 5 illustrates the structure of a motion control system according to a first embodiment.

FIG. 6 illustrates the structure of a motion control system according to a second embodiment.

FIG. 7 illustrates the structure of a motion control system according to a third embodiment.

FIG. 8 illustrates the structure of a motion control system according to a fourth embodiment.

FIG. 9 illustrates the structure of a motion control system according to a fifth embodiment.

FIG. 10 shows wiring in the motion control system in FIG. 9.

FIG. 11 shows wiring in a motion control system in a sixth embodiment of the present invention.

FIG. 12 shows wiring in a motion control system in a seventh embodiment of the present invention.

FIG. 13 illustrates the structure of a conventional motion control system.

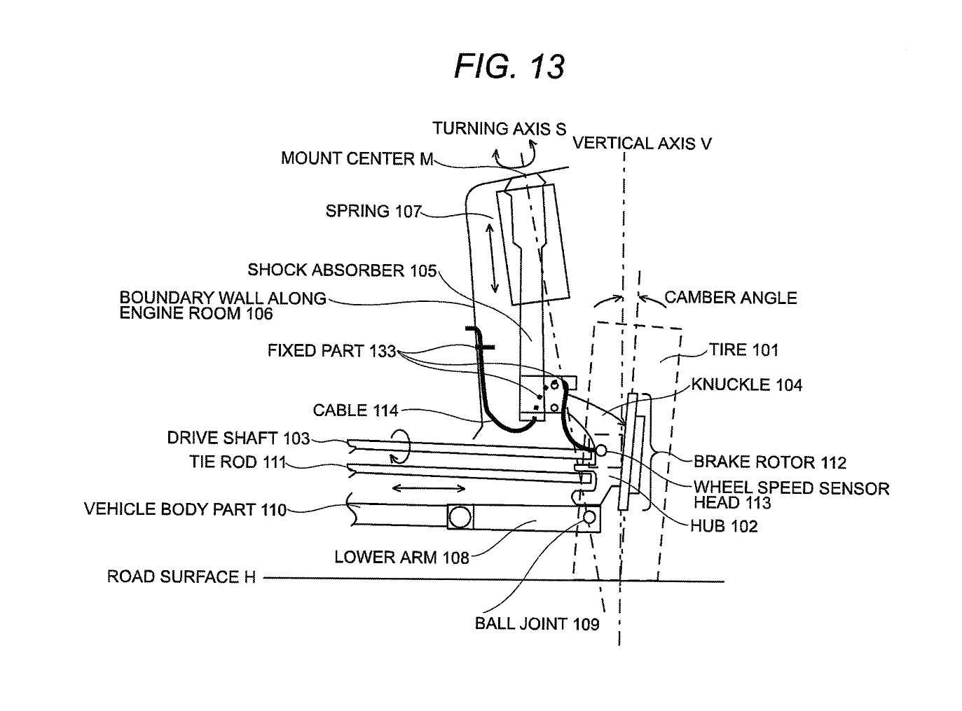

FIG. 14 is a partial plan view of the motion control system in FIG. 13.

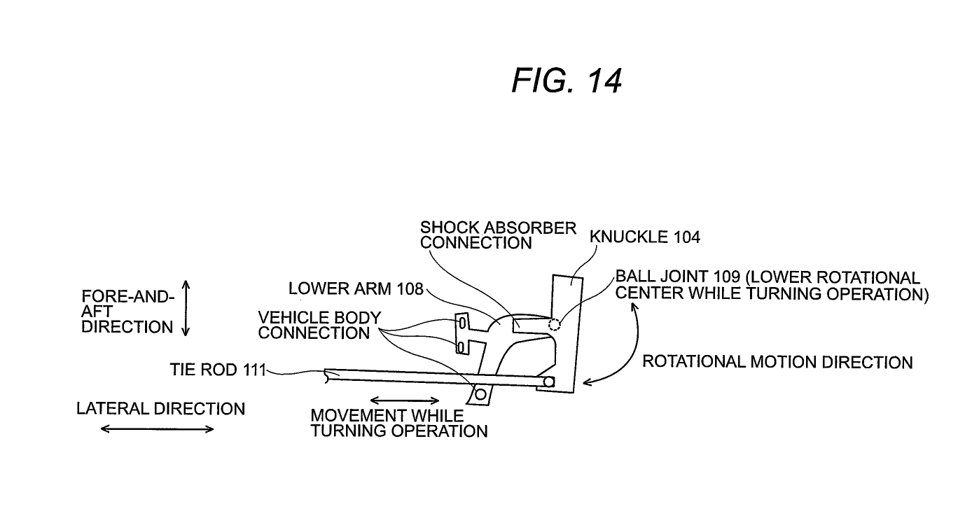

### DESCRIPTION OF EMBODIMENTS

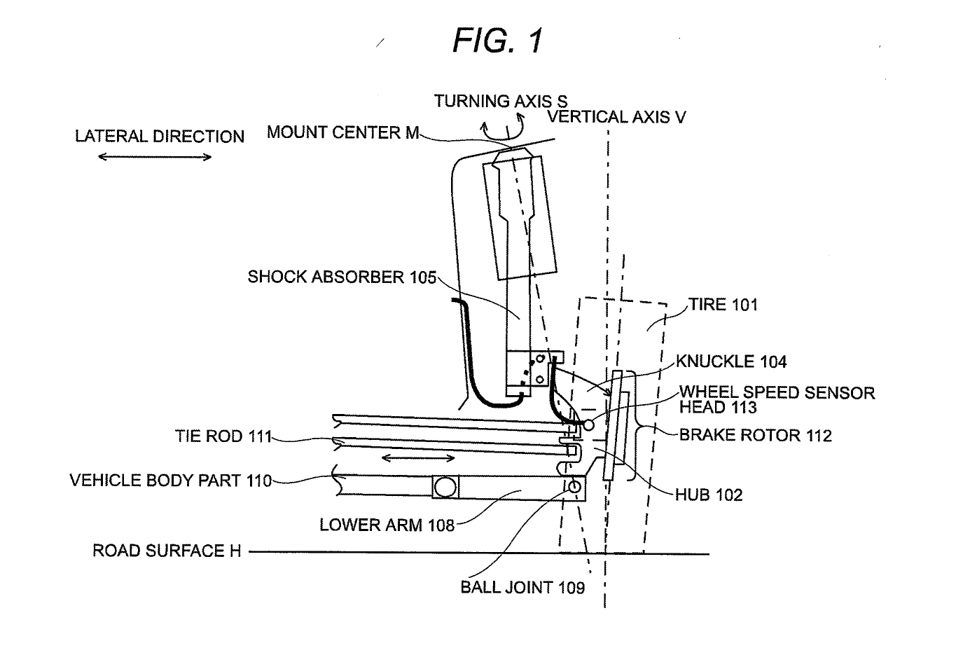

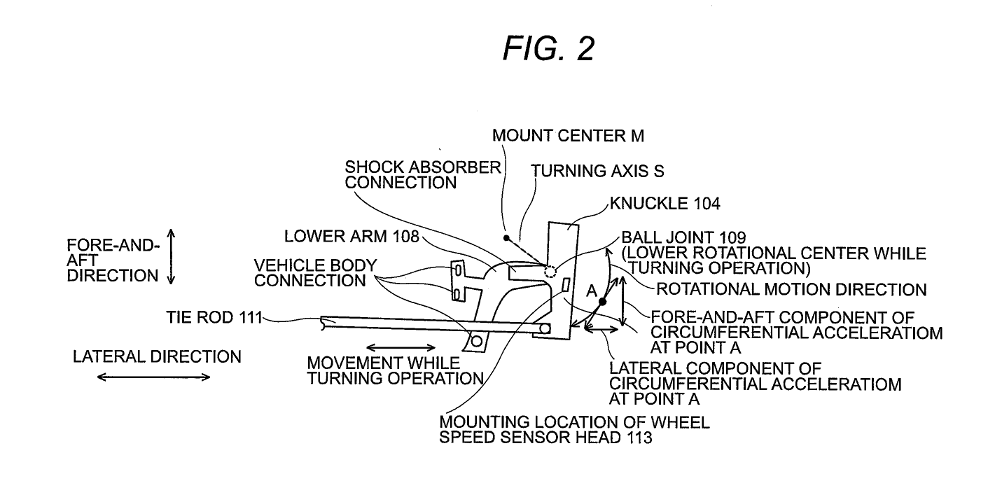

As FIGS. 1 and 2 show, a physical quantity sensor such as an acceleration sensor or an angular rotation speed sensor is provided in the unsprung mass of a moving unit such as a vehicle. Specifically, a physical quantity sensor (not shown) is attached to lower part of the shock absorber 105 or the knuckle 104 rigidly connected to the lower part of the shock absorber 105.

When the moving unit is operated, angular rotational acceleration is also caused by the rotational motion of the operation itself. Accordingly, the acceleration caused by the angular rotational acceleration must not be detected by the acceleration sensor. For this reason, the acceleration sensor is placed so that its detection axis crosses the turning axis that causes angular rotational acceleration. In a situation in which the detection axis crosses the turning axis, the detection axis and the turning axis are in one plane and the detection axis crosses the turning axis in the plane.

When the moving unit is a vehicle, the acceleration sensor is placed so that its axis crosses the wheel turning axis of the moving unit.

It is also possible to use two acceleration sensors. In this case, a first acceleration sensor is placed so that its detection axis crosses the turning axis that causes angular rotational acceleration and a second acceleration sensor is placed so that its detection axis is parallel to the detection axis of the first acceleration sensor and does not cross the turning axis that causes the angular rotational acceleration (the detection axis and the turning axis are not in one plane). Accordingly, the first acceleration sensor crosses a direction of angular rotational acceleration around the turning axis, so an acceleration component in a tangent direction of the angular rotational acceleration is not detected. The detection axis of the second acceleration sensor does not cross the direction of the angular rotational acceleration around the turning axis, so the second acceleration sensor detects the acceleration component in a tangent direction of the angular rotational acceleration. The output of the first acceleration sensor, the output of the second acceleration sensor, and positional relationships among the first acceleration sensor, second acceleration sensor, and the turning axis can be used to obtain the angular rotational acceleration around the turning axis.

A plurality of physical quantity sensors placed in the unsprung mass are interconnected through a series of cables.

When the present invention is applied to a vehicle such as an automobile, the physical quantity sensor such as an acceleration sensor or an angular rotation speed sensor is attached to the knuckle 104 rigidly connected to the hub 102 or the lower part of the shock absorber 105.

One of the plurality of acceleration sensors is placed so that its detection axis crosses a wheel turning axis S.

A physical quantity sensor attachment part is provided midway along the cable 114 of the wheel speed sensor head 113.

Another physical quantity sensor attachment part is provided at a part for fixing the cable 114 of the wheel speed sensor head 113.

The physical quantity sensor attachment part placed midway along the cable 114 of the wheel speed sensor head 113 has a function for relaying information from a wheel speed sensor.

The output of the acceleration sensor, which is placed so that its detection axis crosses the wheel turning axis S and the output of the acceleration sensor, which is placed so that its detection axis does not cross the wheel turning axis S are used to obtain a turning angle acceleration from a difference between the two outputs.

The plurality of physical quantity sensors, such as acceleration sensors, placed in the unsprung mass and the wheel speed sensor are connected with a single harness. An information relaying function can be incorporated in the sensors.

The principle of the present invention will be described below.

To detect the reactive force from the road surface H by measuring deformation or distortion of a structural part, it has been proposed to attach a sensor to the hub 102, where the deformation or distortion can be easily measured. When the sensor is attached to the hub 102, the sensor is brought close to the brake rotor 112 of the disk brake and the drum of the drum brake. Accordingly, it must be considered that the operating temperature limit of the sensor is allowed to at least 150° C.

Since the acceleration of the vehicle changes due to the reactive force from the road surface, the motion of the vehicle can also be checked by detecting the acceleration so as to control the motion. Therefore, the lateral acceleration in the sprung mass of the vehicle has been detected to control the motion. When, however, acceleration is detected in the sprung mass, delayed reactive force from the road surface has been problematic. To address this problem, it is effective to measure the acceleration near the road surface H. When acceleration corresponding to deformation or distortion detected on the hub 102 is detected, a part rigidly connected to the hub 102, that is, the lower part (from the damper mechanism to a portion near the knuckle 104) of the knuckle 104 or the shock absorber 105 is a portion appropriate for the detection. On the lower part of the knuckle 104 or the shock absorber 105, a position farther apart from the brake disk, which is a heat generating body, than on the hub 102 can be selected. The lower part is also appropriate from the viewpoint of lowering the upper limit of the operating temperature range (For example, reducing to 85° C. or below).

An acceleration sensor can also be attached to the part rigidly connected to the hub 102 so that the detection axis is orthogonal to the rotational direction of the wheel, in which case acceleration orthogonal to the rotational direction of the wheel (that is, acceleration in the rotational axis direction of the vehicle) is directly detected instead of acceleration orthogonal to the direction in which the vehicle moves (acceleration in the lateral direction of the vehicle). The acceleration sensor attached to the vehicle body detects acceleration orthogonal to the direction in which the vehicle moves. To check the motion of the wheel with respect to the reactive force from the road surface H, however, acceleration orthogonal to the rotational direction of the wheel should be used. In the following description, acceleration orthogonal to the rotational direction of the wheel is referred to as the lateral acceleration.

The lower part of the knuckle 104 or the shock absorber 105 moves when the wheel is turned by operating the handle. Accordingly, to detect the acceleration corresponding to vehicle motion, the problem described below must be overcome.

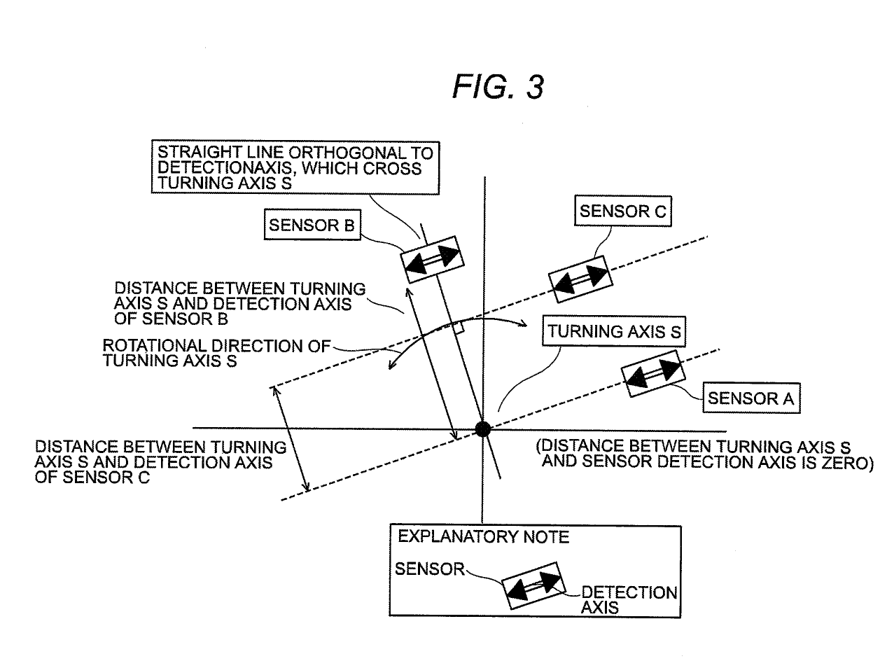

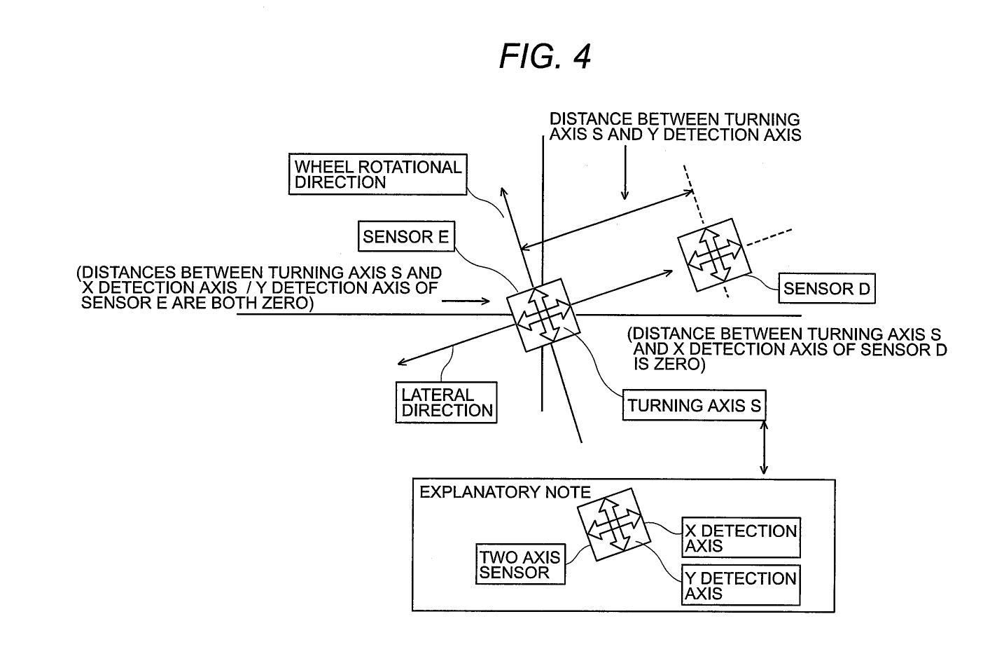

When the acceleration sensor for detecting the lateral acceleration is attached near the wheel to be turned, the circumferential component of the angular rotational acceleration (angular rotational acceleration around the wheel turning axis S) caused by the turning operation is added to the acceleration sensor, so it is not possible to detect only the acceleration caused by the force received from the road surface H. Since, however, the circumferential component of the angular rotational acceleration is proportional to the distance between the wheel turning axis S and the detection axis of the sensor, the radius can be set to 0 by placing the acceleration sensor so that its detection axis crosses the wheel turning axis S. The lateral acceleration can then be detected without being affected by the angular rotational acceleration caused by the turning operation. This will be described in detail with reference to FIGS. 3 and 4.

FIG. 3 illustrates an example in which each sensor uses a single detection axis. Sensor A in FIG. 3 is placed so that its detection axis crosses the turning axis S, and sensors B and C are placed so that their detection axes do not cross the turning axis S.

The distance between the turning axis S and the detection axis of each sensor is measured as the minimum distance between them. If the distance between the turning axis S and the detection axis of a sensor is 0, the output of the sensor is not affected by the motion component (the circumferential component of the angular acceleration, for example) during the turning operation. In the example in FIG. 3, the detection axis of sensor A crosses the turning axis S, so the distance between the detection axis and turning axis S is 0. For sensors B and C, however, there are distances between their detection axes and the turning axis S, as indicated in the drawing. Accordingly, the output of sensor A is not affected by the turning, but outputs from sensors B and C are affected.

Although the detection axes of sensors A to C are oriented in the same direction, these detection axes can be orthogonal to the rotational direction of the wheel, for example. If sensors A to C are acceleration sensors, they detect the lateral acceleration of the wheel. However, only sensor A can detect the lateral acceleration without being affected by the angular acceleration due to the turning operation.

FIG. 4 illustrates another example in which two-axis sensors, each of which has two detection axes, are used. Sensors D and E each have two detection axes, x detection axis and y detection axis, that are internally orthogonal to each other.

Sensor D in FIG. 4 is placed so that the x detection axis crosses the turning axis S but the y detection axis does not cross the turning axis S. Accordingly, the distance between the x detection axis of sensor D and the turning axis S is 0, preventing the sensor output related to the x detection axis from being affected by the turning operation. However, there is a distance between the y detection axis of sensor D and the turning axis S, as indicated in the drawing, causing the sensor output related to the y detection axis to be affected by the turning axis S. Even when sensor D is placed as shown in the drawing, if two sensors are used as described later, the effect of turning can be compensated.

Sensor E is placed so that both the x detection axis and y detection axis cross the turning axis S. Accordingly, the distance between the x detection axis and turning axis S and the distance between the y detection axis and the turning axis S are both 0, preventing the two sensor outputs from being affected by the turning operation.

When a two-axis sensor as shown in FIG. 4 is used, not only the lateral acceleration but also the acceleration in the rotational direction (that is, the direction in which the wheel moves) of the wheel can be measured with a single sensor. The cost of a single two-axis sensor and its mounting cost can be reduced as compared with the use of two one-axis sensors.

The effects caused by turning a wheel of a vehicle will be described with reference to FIGS. 1 and 2. Although the wheel turning axis of the vehicle depends on the type of suspension, if the suspension is a strut suspension, a line connecting a mount center M and a ball joint 109 is the wheel turning axis S. The mount center M is the center of the plane, in which the shock absorber 105 is connected to the vehicle. The wheel is turned when the rotation of the handle (not shown) is converted to lateral motion of the tie rod 111 by a rack-and-pinion mechanism (not shown) provided at an intermediate point and then the knuckle 104 connected to the tie rod 111 turns around the ball joint 109.

Angular rotational acceleration is added during the wheel turning operation at a point apart from the wheel turning axis S (the position of the wheel speed sensor head 113, for example), generating acceleration in the circumferential direction of the turning axis S. Accordingly, when an acceleration sensor is placed so that it has sensitivity in the circumferential direction around the turning axis S, the angular rotational acceleration caused by motion due to the turning operation is superimposed to the output of the acceleration sensor.

When an acceleration sensor for detecting the lateral acceleration caused by the reactive force from the road surface H or an acceleration sensor for detecting fore-and-aft acceleration is placed so that its detection axis does not cross the turning axis S, the effect of the angular acceleration generated by the turning operation becomes an error. This error is proportional to the distance between the turning axis S and acceleration detection axis. Strictly, there is also an effect of this error when vertical acceleration is detected. However, the angle formed between the turning axis S and the vertical axis is small, so the effect is smaller than when the lateral or fore-and-aft acceleration is detected.

Since the acceleration sensor in the present invention is placed so that its detection axis crosses the turning axis S, the effect of angular acceleration generated by a turning operation is eliminated.

The turning axis S also moves a little together with the motion of the vehicle. If, however, the position at which to place the acceleration sensor is determined with respect to the turning axis S while the vehicle is stopping without being turned, the sensor output is less likely to be affected, on the average, by angular acceleration generated by the turning operation.

Suppose that the above description is applied to a general moving unit. If an angular rotational acceleration is generated when a motion operation is performed on the moving unit, the above description is equivalent to an acceleration sensor that does not detect a phenomenon accompanying the angular rotational acceleration being placed so that its detection axis crosses the turning axis of the motion operation.

When the first acceleration sensor for detecting the lateral acceleration or fore-and-aft acceleration is placed so that its detection axis crosses the wheel turning axis S and the second acceleration sensor is placed so that its detection axis is parallel to the detection axis of the first acceleration sensor and does not cross the wheel turning axis S, acceleration caused by angular rotational acceleration due to a turning operation can be separately detected. That is, when the output of the first acceleration sensor, which is parallel to the detection axis of the second acceleration sensor, is subtracted from the output of the second acceleration sensor, which includes acceleration due to the turning operation, acceleration, due to the turning operation, on the detection axis of the second acceleration sensor can be obtained. If the distance between the detection axis of the second acceleration sensor and the wheel turning axis is obtained in advance, the angular rotational acceleration due to the turning operation can be obtained. If the obtained angular rotational acceleration is integrated, the angular rotation speed due to the turning operation can be obtained. If the obtained angular rotation speed due to the turning operation is further integrated, the amount of turning can be obtained.

The turning axis also moves a little together with the motion of the vehicle. If this is taken into consideration, the turning angle rotational acceleration obtained by the method described above can also be used in the analysis of vehicle motion.

The amount of turning is substantially proportional to the amount by which the handle is turned. If a sensor for detecting the amount of steering, which corresponds to the amount of handle turning, is used, a substantial amount of turning can be obtained. To detect the amount of steering, a rotational angular sensor for the handle, a motion amount detection sensor for the tie rod 111, or the like has been used. However, the amount of turning is not always proportional to the amount of steering due to a mechanical compliance of the steering system. The difference between the amount of turning and the amount of steering becomes more outstanding as the behavior of the vehicle comes closer to its limit. In order to ensure stable running, therefore, it is important to obtain the actual amount of turning. Thus detecting the turning angle acceleration by the above method is effective.

If a signal is relayed at a place in the unsprung mass at which the physical quantity sensor is attached, a signal transmitting distance from the wheel speed sensor attached to the hub 102 is shortened. The wheel speed sensor attached to the hub 102 is required to operate in a high-temperature environment. The load applied to a signal transmitting part can be reduced by shortening the transmitting distance. When the signal transmitting load applied to the high-temperature part is reduced, the space to mount the high-temperature part can be easily reduced and its weight and cost can be easily reduced.

When the relaying part has an information multiplexing function, it is also possible to reduce the number of necessary conductors.

Specific embodiments in the present invention will be described below.

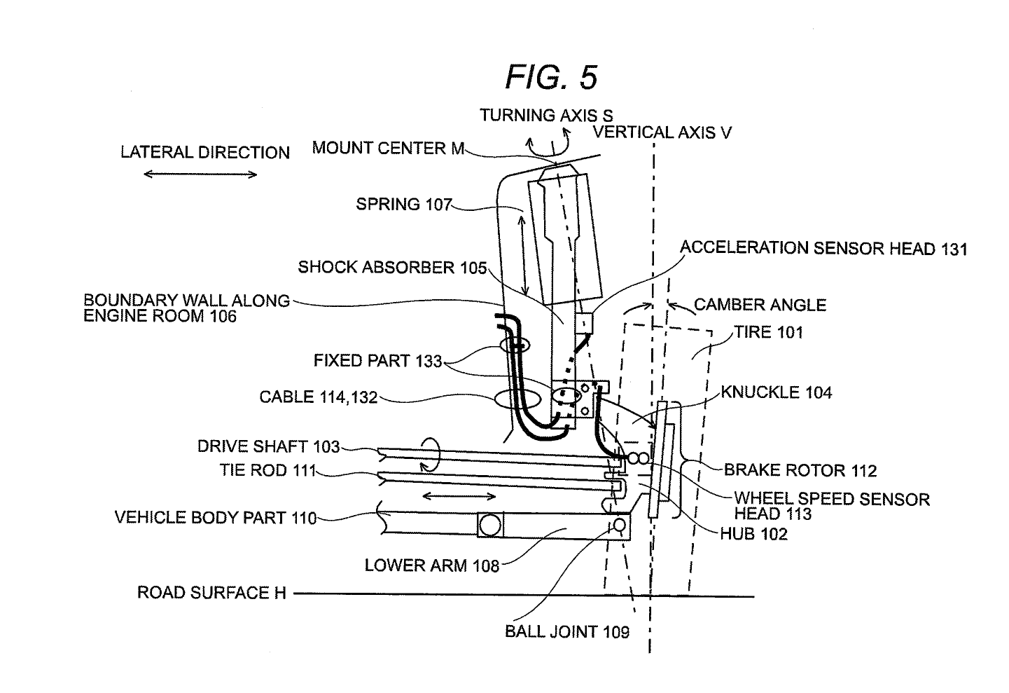

FIG. 5 shows a motion control system according to a first embodiment of the present invention, which an acceleration sensor is attached to the right front wheel of a front-wheel-drive vehicle. An acceleration sensor head 131 including an acceleration sensor for detecting lateral acceleration is attached to the lower part (below the spring 107) of the shock absorber 105 with a bracket or the like at a position where the detection axis of the acceleration sensor crosses the turning axis S. A cable 132 connected to the acceleration sensor head 131 is fixed at a cable securing part 133 (the lower part of the shock absorber 105), fixed at another cable securing part 133 (the boundary wall 106 along the engine room) with a sag, and connected to an acceleration signal processing circuit (not shown) in the engine room. In this embodiment, the cable 114 connected to the wheel speed sensor is also fixed together at the two cable securing parts 133 at which the cable 132 is fixed.

The acceleration sensor can detect lateral acceleration generated when a reactive force is received from the road surface H while the vehicle is moving. When the wheels are turned by operating the handle, acceleration generated by angular rotational acceleration generated by the turning operation does not appear on the acceleration detection axis, enabling the lateral acceleration to be detected without being affected by the turning operation.

The acceleration sensor head 131 can be attached to another wheel by the method described above. For wheels that are not turned, it is not necessary to consider the restrictions in terms of the turning axis S.

The acceleration sensor head 131 can use any one of or a combination of the acceleration sensor for detecting lateral acceleration, the acceleration sensor for detecting fore-and-aft acceleration, and the acceleration sensor for detecting vertical acceleration.

To detect the lateral acceleration, fore-and-aft acceleration, and vertical acceleration, a single acceleration sensor with a detection axis angled with respect to axes for these accelerations can be used alone or a plurality of acceleration sensors of this type can be used in combination. When the detection axis of the acceleration sensor is displaced from the vertical axis V, acceleration at a prescribed angle, for example, in a horizontal direction, can be obtained because the acceleration of gravity is known.

A physical quantity sensor other than the acceleration sensor, such as an angular rotation speed sensor, can be used. When an angular rotation speed sensor for measuring angular rotation speed around the wheel turning axis S is mounted, the angular rotation speed can be directly measured.

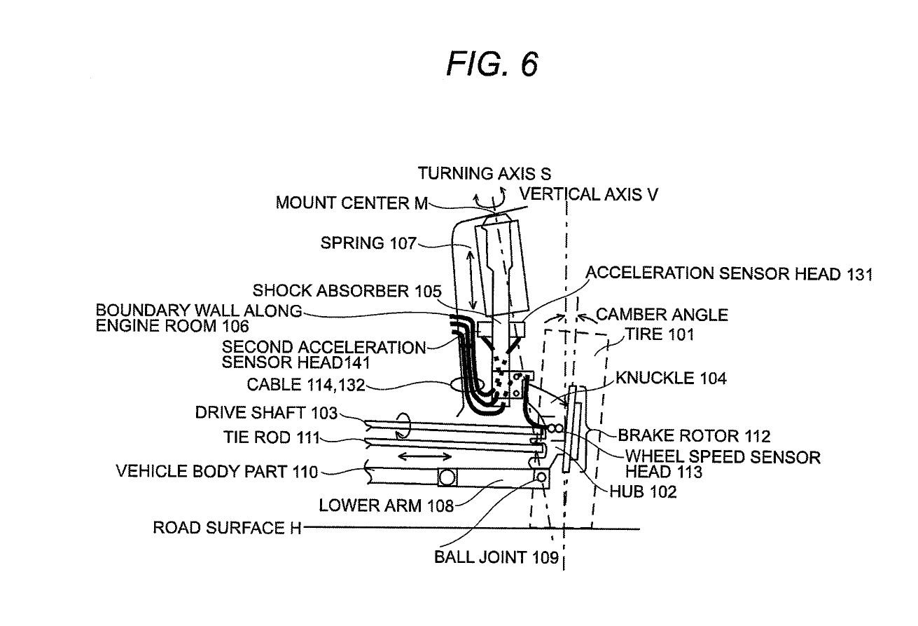

FIG. 6 shows a second embodiment of the present invention. In addition to one acceleration sensor head (first acceleration sensor head) 131 used in the first embodiment, a second acceleration sensor head 141 including a second acceleration sensor is mounted in the second embodiment. The second acceleration sensor head 141 is attached to the shock absorber 105 on a side opposite to the side on which the first acceleration sensor head 131 is attached. The acceleration sensor, included in the second acceleration sensor head 141, for detecting lateral acceleration is placed so that the detection axis of the acceleration sensor does not cross the turning axis S and is parallel to the detection axis of the lateral acceleration sensor in the first acceleration sensor head 131. The position at which the acceleration sensor is placed is displaced from the turning axis S. The distance between the first acceleration sensor and the second acceleration sensor should be reduced as much as possible because disturbance such as vibration is exerted on these acceleration sensors to the same extent, and thereby the effect of the disturbance can be easily reduced in differential processing.

Since the first acceleration sensor (in the first acceleration sensor head 131) for detecting lateral or fore-and-aft acceleration is placed so that its detection axis crosses the wheel turning axis S and the second acceleration sensor (in the second acceleration sensor head 141) is placed so that its detection axis is parallel to the detection axis of the first acceleration sensor and does not cross the wheel turning axis S, angular acceleration due to a turning operation can be separately detected. That is, when the output of the first acceleration sensor, which is parallel to the detection axis of the second acceleration sensor and does not include acceleration generated by the turning operation, is subtracted from the output of the second acceleration sensor generated by angular rotational acceleration due to the turning operation, the acceleration generated on the detection axis of the second acceleration sensor by the turning operation can be obtained. If the distance between the detection axis of the second acceleration sensor and the wheel turning axis S is obtained in advance, the angular rotational acceleration due to the turning operation can be obtained.

An acceleration sensor consists of the first acceleration sensor head 131 and second acceleration sensor head 141, which is placed so that detection axis of the first acceleration sensor head 131 and second acceleration sensor head 141 are parallel to each other, can be the sensor detecting acceleration in a horizontal plane (more precisely, in a plane orthogonal to the turning axis S), instead of detecting lateral acceleration.

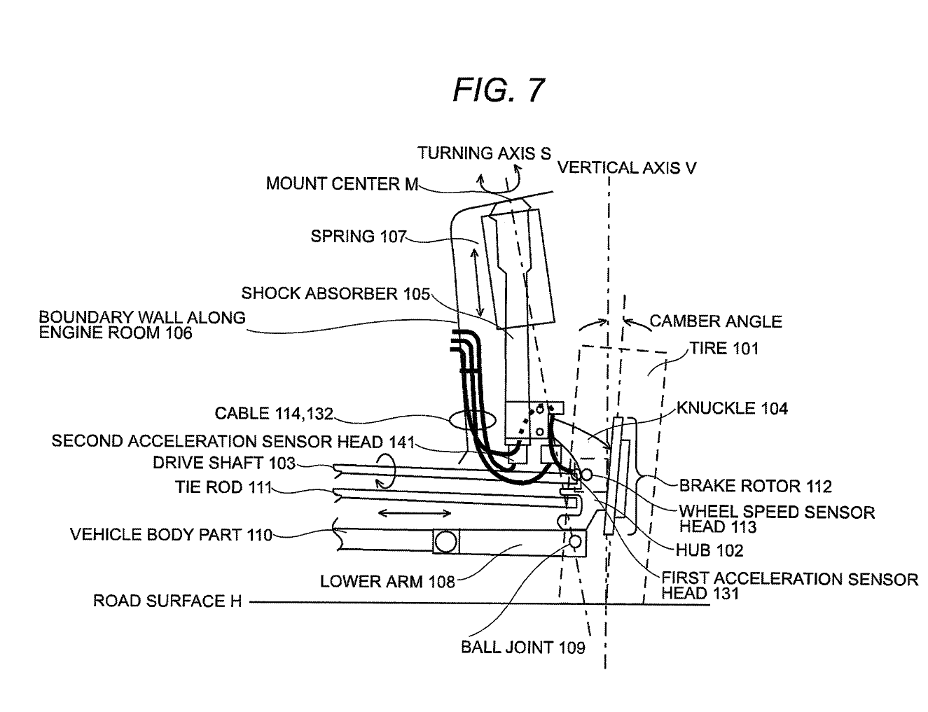

FIG. 7 shows a third embodiment of the present invention. In this embodiment, the first acceleration sensor head 131 is placed on the turning axis S at the lower part of the knuckle 104, and the second acceleration sensor head 141 is placed at a position apart from the turning axis S so that its detection axis does not cross the turning axis S. If angular acceleration due to a turning operation does not need to be obtained, it suffices to mount only the first acceleration sensor head 131. Since the first acceleration sensor head 131 is positioned closer to the brake rotor 112 than in the first and second embodiments, the temperature in the environment in which the sensors are used is raised. The first acceleration sensor head 131 is also brought close to the road surface H, the risk of cables being caught by objects on the road is increased. When these problems are overcome by the structural design of the vehicle, an arrangement as shown in FIG. 7 is possible.

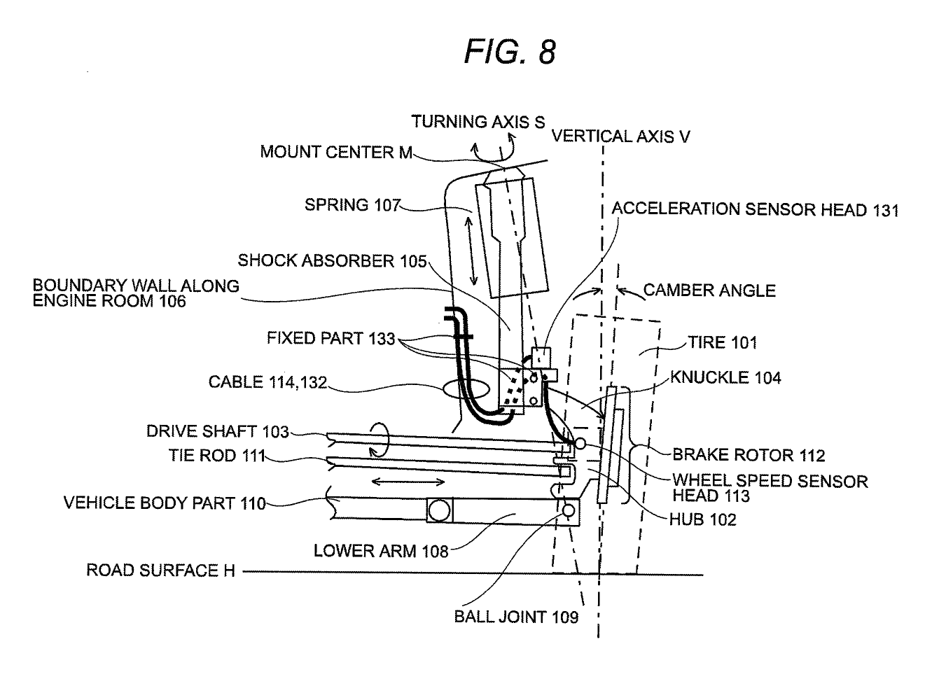

FIG. 8 shows a fourth embodiment of the present invention. In this embodiment, the acceleration sensor head 131 is attached to the securing part at which the wheel speed sensor cable is fixed. In this placement, the member for fixing the acceleration sensor can also be used to fix the wheel speed sensor cable together, reducing the member cost, member weight, and assembling man-hours.

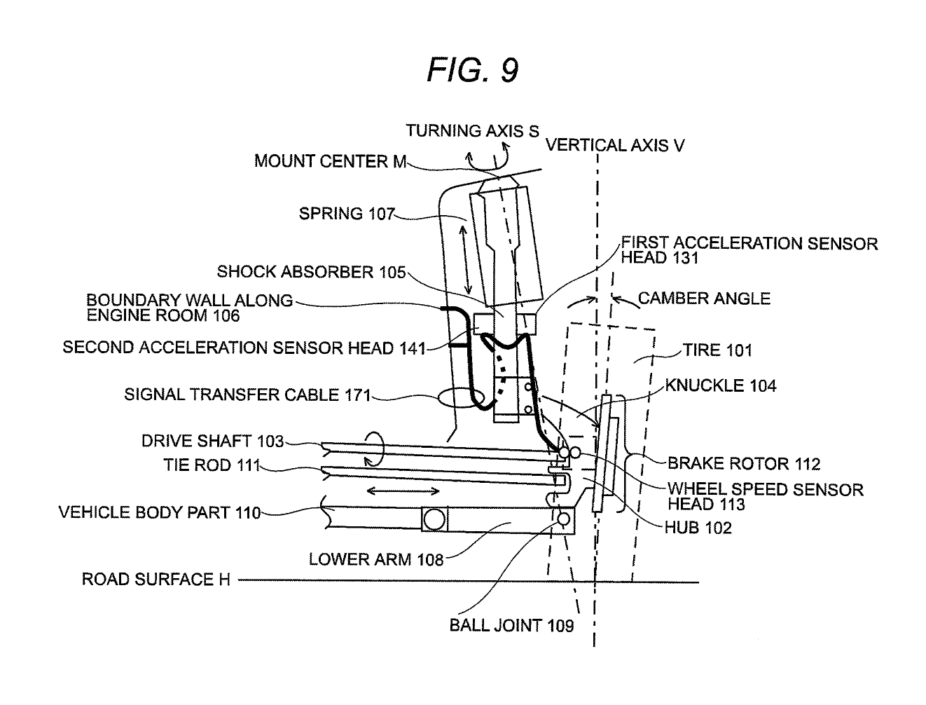

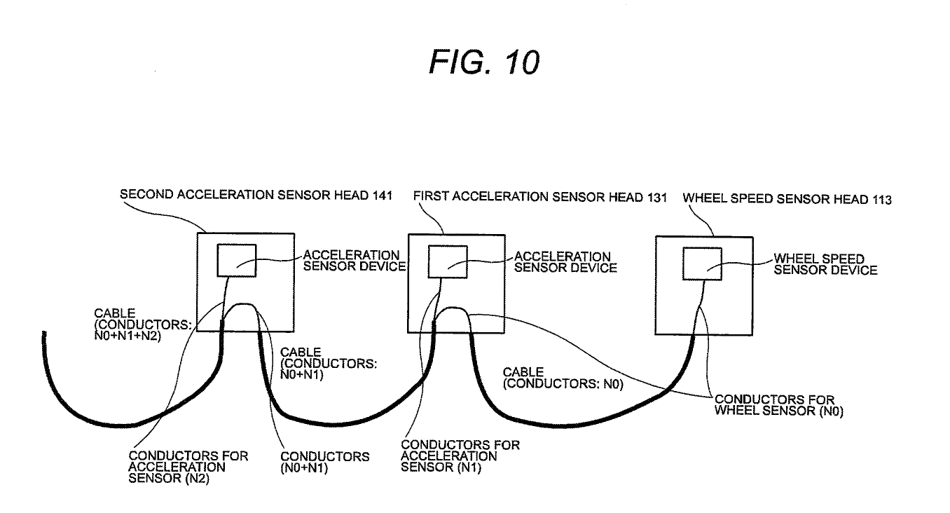

FIGS. 9 and 10 show a fifth embodiment of the present invention. In this embodiment, the first acceleration sensor head 131, second acceleration sensor head 141, and wheel speed sensor head 113 are interconnected with a signal submitting cable 171. Suppose that the number of conductors used by the wheel speed sensor is N0, the number of conductors used by the first acceleration sensor is N1, and the number of conductors used by the second acceleration sensor is N2. Then, the number of conductors of a cable for interconnecting the wheel speed sensor head 113 and first acceleration sensor head 131 is N0, the number of conductors of a cable for interconnecting the first acceleration sensor head 131 and second acceleration sensor head 141 is N0+N1, and the number of conductors of a cable for connecting the second acceleration sensor head 141 to an electric circuit in the engine room is N0+N1+N2. An intermediate sensor head is used to relay conductors used by a sensor head upstream of the intermediate sensor. In this arrangement, cables in the unsprung mass can be connected in a series of cables, reducing the space for cable wiring in the unsprung mass, the mass of the cables and securing brackets, and material costs. The three sensor heads can be manufactured in advance as a harness that connects the three sensor heads with a series of cables, so the number of man-hours for assembling the vehicle can be reduced. Conductors can be relayed at each sensor head by soldering, welding, or another means.

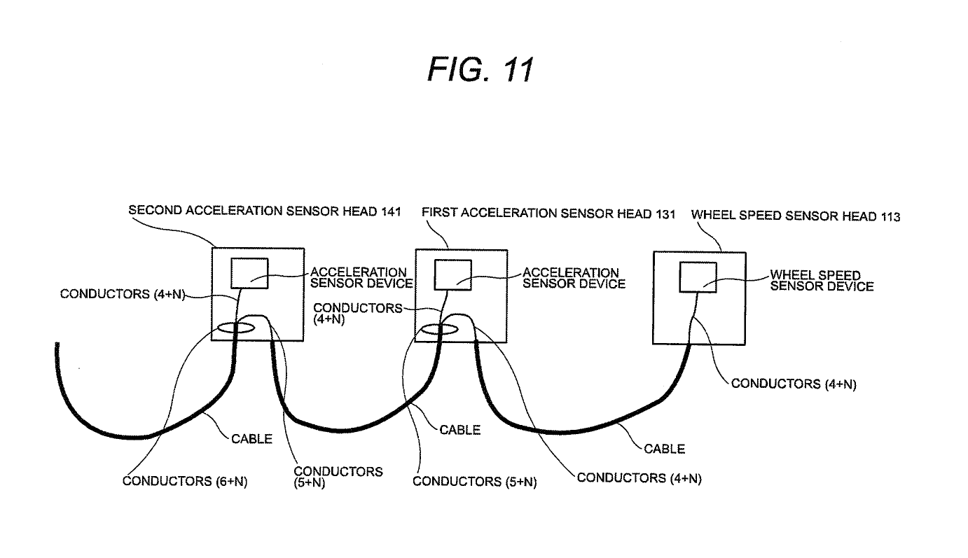

FIG. 11 shows a sixth embodiment of the present invention. In this embodiment, the devices of the acceleration sensor and wheel speed sensor have an SPI interface. When the SPI interface is used, the number of conductors needed to use a plurality of devices is just 3+number of sensors+N (number of power supplies), making the number of conductors used smaller than in the fifth embodiment.

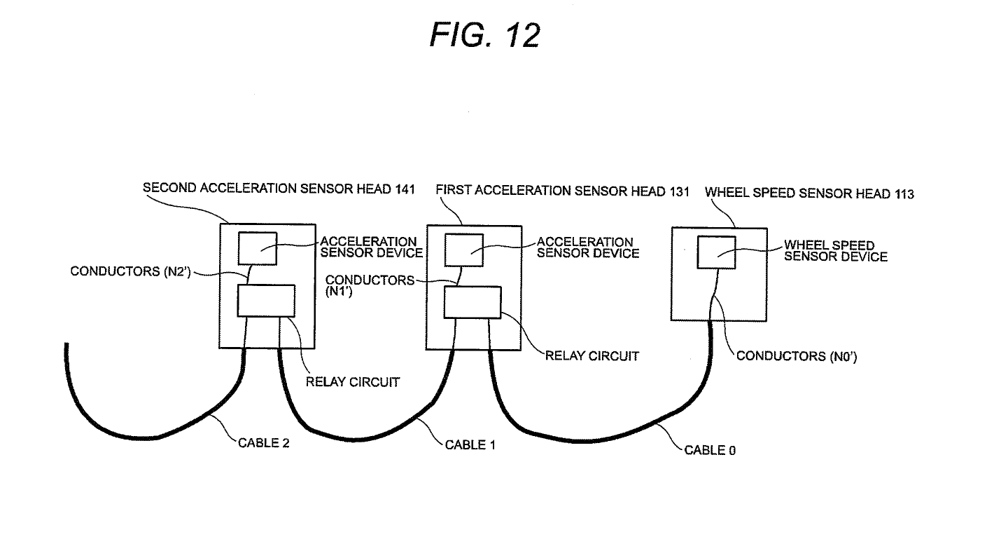

FIG. 12 shows a seventh embodiment of the present invention. In this embodiment, the intermediate sensor head has a relay circuit for relaying information about a sensor upstream of the intermediate sensor by performing multiplexing processing or the like. In this case, it is possible that the cable 2 has the same number of conductors as the cable 1.

Other methods for relaying signals (conductors) of a plurality of sensors are also available. An appropriate relay method can be selected by considering the advantages and disadvantages of these methods.

Examples of using two acceleration sensor heads by connecting them with a series of cables have been described. When only one acceleration sensor is used, it suffices to interconnect the acceleration sensor head and wheel speed sensor head 113 with a series of cables. Even if four or more sensor heads are used, they can be connected in the same way.

A plurality of sensor heads can be connected with a series of cables in any sequence. They should be connected in a sequence that simplifies the mounting.

Although vehicles using a strut suspension have been described in the above embodiments, the present invention can also be applied to vehicles using a double wishbone suspension or another type of suspension. That is, when a physical quantity sensor is placed in an area below a spring attached to a member for supporting a wheel to the body, the same effect as in the above embodiments is provided. Furthermore, when sensors are attached with respect to the wheel turning axis and the detection axis of the physical quantity sensor, the effect of angular rotational acceleration generated by rotational motion during an operation can be eliminated as in the above embodiments.

Although the acceleration sensor is placed so that its detection axis crosses the wheel turning axis in the same plane to eliminate the effect of angular rotational acceleration generated by a turning operation, this is not a limitation; even if the detection axis does not strictly cross the wheel turning axis in the same plane, if the distance between the wheel turning axis and the detection axis of the acceleration sensor is short, the effect of the angular rotational acceleration is small (the effect is proportional to the distance). If a design of a vehicle allows the distance between the wheel turning axis and detection axis to be in a range in which the above effect of angular rotational acceleration by a turning operation is not an obstacle, the detection axis does not need to strictly cross the wheel turning axis in the same plane.

Although the above embodiments have been described on the assumption that the present invention is applied to vehicles, the present invention can also be applied to a moving unit that moves by receiving a reactive force from its circumference and has a sprung mass through a spring or damper for reducing the effect of the reactive force and has an unsprung mass which is closer to a reactive force generating source than the damper or spring. Alternatively, the present invention can also be applied to a moving unit that has a mechanism for generating angular rotational acceleration when an operation for moving the moving unit is performed. For example, the present invention can also be applied to railroad vehicles and moving robots.

It should be understood that the motion control sensor system described in the above embodiments can be used to implement a vehicle motion control system that, for example, suppresses under steering, over steering, and slipping and preventing the vehicle from rollover.

It should also be understood that the motion control system can use not only information from the motion control sensor system according to the present invention but also information from a conventional wheel speed sensor. That is, the functions of the motion control system can be improved by using information from other sensors, including an acceleration sensor placed in the sprung mass, an angular speed sensor, a handle steering angle detection sensor, and a torque sensor, together.

When the motion control sensor system according to the present invention is combined with a conventional wheel speed sensor or the like, the space in which to place the sensors (cables), the weight and mass of the sensor system, and assembling man-hours can be reduced.

According to the present invention, a motion control sensor that reduces delay of a signal detected as a response from a road surface can be provided.

Since the sensor is placed close to a non-rotating part, there is no need to supply power to the rotating part and transfer information from the rotating part.

It will be obvious to those having skill in the art that many changes may be made in the above-described details of the preferred embodiments of the present invention. The scope of the present invention, therefore, should be determined by the following claims.

1. A motion control sensor system for a moving unit such as a vehicle, wherein a physical quantity sensor is provided in an unsprung mass of the moving unit, the unsprung mass being positioned below a spring attached to a member for supporting a wheel to a vehicle body of the moving unit in a path from the vehicle body to the wheel.

2. The motion control sensor system for a moving unit according to claim 1, wherein:
the physical quantity sensor is an acceleration sensor for detecting acceleration exerted on the unsprung mass of the moving unit; and
the acceleration sensor is placed so that a detection axis of the acceleration sensor crosses a turning axis of the moving unit.

3. The motion control sensor system for a moving unit according to claim 1, wherein:
the physical quantity sensor comprises a first acceleration sensor and a second acceleration sensor, the first acceleration sensor and the second acceleration sensor detecting acceleration exerted on the unsprung mass of the moving unit;
the first acceleration sensor is placed so that a detection axis of the first acceleration sensor crosses a turning axis of the moving unit; and
the second acceleration sensor is placed so that a detection axis of the second acceleration sensor is parallel to the detection axis of the first acceleration sensor and does not cross the turning axis of the moving unit.

4. The motion control sensor system for a moving unit according to claim 1, wherein a plurality of physical quantity sensors are placed in the unsprung mass of the moving unit, the plurality of physical quantity sensors being interconnected through a series of cables.

5. The motion control sensor system for a moving unit according to claim 2, wherein a plurality of physical quantity sensors are placed in the unsprung mass of the moving unit, the plurality of physical quantity sensors being interconnected through a series of cables.

6. The motion control sensor system for a moving unit according to claim 3, wherein a plurality of physical quantity sensors are placed in the unsprung mass of the moving unit, the plurality of physical quantity sensors being interconnected through a series of cables.

7. A motion control system for a moving unit comprising:
a motion control sensor system, wherein a physical quantity sensor is provided in an unsprung mass of the moving unit, the unsprung mass being positioned below a spring attached to a member for supporting a wheel to a vehicle body of the moving unit in a path from the vehicle body to the wheel.

8. The motion control system for a moving unit according to claim 7, wherein:
the physical quantity sensor is an acceleration sensor for detecting acceleration exerted on the unsprung mass of the moving unit; and
the acceleration sensor is placed so that a detection axis of the acceleration sensor crosses a turning axis of the moving unit.

9. The motion control system for a moving unit according to claim 7, wherein:
the physical quantity sensor comprises a first acceleration sensor and a second acceleration sensor, the first acceleration sensor and the second acceleration sensor detecting acceleration exerted on the unsprung mass of the moving unit;
the first acceleration sensor is placed so that a detection axis of the first acceleration sensor crosses a turning axis of the moving unit; and
the second acceleration sensor is placed so that a detection axis of the second acceleration sensor is parallel to the detection axis of the first acceleration sensor and does not cross the turning axis of the moving unit.

10. The motion control system for a moving unit according to claim 7, wherein a plurality of physical quantity sensors are placed in the unsprung mass of the moving unit, the plurality of physical quantity sensors being interconnected through a series of cables.

11. The motion control system for a moving unit according to claim 8, wherein a plurality of physical quantity sensors are placed in the unsprung mass of the moving unit, the plurality of physical quantity sensors being interconnected through a series of cables.

12. The motion control system for a moving unit according to claim 9, wherein a plurality of physical quantity sensors are placed in the unsprung mass of the moving unit, the plurality of physical quantity sensors being interconnected through a series of cables.
